(19) United States
(12) Patent Application Publication
(10) Pub. No.: US 2005/0275299 A1
(43) Pub. Date: Dec. 15, 2005

(54) Motor with rotational balancing structure

(75) Inventors: Alex Horng, Kaohsiung (TW); Yin-Rong Hong, Kaohsiung (TW)

Correspondence Address: BACON & THOMAS, PLLC, 625 SLATERS LANE, FOURTH FLOOR, ALEXANDRIA, VA, 22314, US

(73) Assignee: Sunonwealth Electric Machine Industry Co., Ltd., Kaohsiung (TW)

(21) Appl. No.: 10/863,265

(22) Filed: Jun. 9, 2004

(51) Int. Cl. H02K 7/00; H02K 11/00

(52) U.S. Cl. 310/90.5

(57) ABSTRACT

A motor includes an axial tube mounted in a stator, a rotor, a balancing magnet, and a magnetically conductive member. The rotor includes an axial base formed on an inner face thereof and a shaft extending from the axial base through a bearing received in the axial tube. The balancing magnet is mounted to the upper end of the axial tube. The magnetically conductive member is mounted to a bottom end of the shaft base of the rotor. At least one face of the balancing magnet faces and attracts at least one face of the magnetically conductive member to maintain rotational balance and starting balance of the rotor. The magnetically conductive member may be replaced with a magnetically conductive portion integrally formed with the shaft.

### BACKGROUND OF THE INVENTION

1. Field of the Invention

The present invention relates to a motor. In particular, the present invention relates to a motor with a rotational balancing structure.

2. Description of Related Art

Taiwan Utility Model Publication No. 383818 discloses a heat dissipating fan with a magnetic balancing effect. As illustrated in FIG. 1 of the drawings, the heat dissipating fan comprises a stator 10, an axial tube 20, a rotor 30, and a magnetically conductive metal plate 301. The stator 10 is fixed on a base 100 by the axial tube 20 and includes a plurality of pole plates 11. At least one bearing 21 is mounted in the axial tube 20. The rotor 30 includes a shaft 31 extending through the bearing 21 and an annular magnet 32 surrounding the pole faces of the pole plates 11. The magnetically conductive metal plate 301 is mounted to an inner face of the rotor 30 and faces top faces of the pole plates 11. When the motor turns, the magnetically conductive metal plate 301 is attracted by the pole plates 11 as a result of alternating magnetization, assisting in rotational balance of the rotor 30 and preventing the rotor 30 from disengaging from the stator 10. Rotational wear to the bearing 21 is reduced and the life of the motor is prolonged.

However, since the magnetically conductive metal plate 301 is directly attracted by the pole plates 11 as a result of alternating magnetization, magnetic leakage may occur in the pole plates 11, leading to reduction in the magnetization efficiency of the pole plates 11. Further, the magnetically conductive metal plate 301 is relatively large and thus causes a burden to the rotor 30. Further, before starting the motor, the pole plates 11 are unable to attract the magnetically conductive metal plate 301 such that a temporary imbalance occurs during starting of the motor. As a result, the bearing 21 is worn out after a long-term use. Further, the pole plates 11 provide a limited rotational balancing effect, as the pole plates 11 provide attraction to the magnetically conductive metal plate 301 in only one direction.

Another type of motor is disclosed in, e.g., Taiwan Utility Model Publication Nos. 422365 and 428838, and U.S. Pat. No. 6,097,120. The motor of this type comprises a stator, a rotor, and a magnetically conductive metal plate mounted to a bottom end of the stator and faces a bottom portion of an annular magnet on the rotor to thereby improve rotational balance of the rotor. Nevertheless, magnetic leakage still occurs, as the magnetically conductive metal plate is in intimate contact with the pole plates and thus causes short circuit of the electric elements on a circuit board. Further, the rotational balancing effect is limited, as the annular magnet attracts the magnetically conductive metal plate in only one direction.

A further type of motor is disclosed in, e.g., U.S. Pat. No. 6,483,209. The motor of this type comprises a stator, a rotor, and a magnetically conductive metal plate mounted to a bottom end of the stator. The magnetically conductive metal plate includes an upright annular wall that faces a bottom portion of an annular magnet on the rotor to thereby improve rotational balance of the rotor. Nevertheless, the upright annular wall occupies the space for mounting blades of the rotor in a case that the upright annular wall faces the bottom portion of an outer periphery of the annular magnet. On the other hand, in a case that the annular wall of the magnetically conductive metal plate faces the bottom portion of an inner periphery of the annular magnet, magnetic leakage still occurs, the gap between the annular magnet and the pole plates is increased, and the overall size of the motor is increased.

Still another type of motor is disclosed in, e.g., U.S. Pat. No. 6,700,241. The motor of this type comprises a rotor, a stator with a plurality of pole plates, and a prestressing magnet fixed by a fixing element on the pole plates of the stator. The prestressing magnet attracts a metal housing of the rotor to thereby improve rotational balance of the rotor. Nevertheless, such a prestressing magnet can only be used with rotors of the type having a metal housing, such as those used in spindle motors for optical disk drives. Namely, the prestressing magnet cannot be used with brushless D.C. rotors that are made of a plastic material by molding injection. Further, a prestressing magnet of a relatively small size provides a relatively small magnetic force which may be insufficient to attract a metal housing of a relatively large size. Further, the prestressing magnet mounted on the pole plates of the stator interferes with alternating magnetization of the pole plates and thus adversely affects the rotational efficiency of the rotor. Further, the prestressing magnet attracts the metal housing in only one direction and thus provides a limited balancing effect.

Yet another type of motor is disclosed in, e.g., U.S. Pat. No. 6,448,675. The motor of this type comprises a rotor, a stator, a balancing plate mounted to one of a bottom end of the stator and a bottom end of the rotor, and a permanent magnet mounted to the other of the bottom end of the stator and the bottom end of the rotor, with the permanent magnet attracting the balancing plate to thereby improve rotational balance of the rotor. Nevertheless, the alternating magnetization efficiency of the stator is adversely affected if the permanent magnet or the balancing plate is mounted to the bottom end of the rotor or if the permanent magnet and the balancing plate are both mounted in a central hole of the stator. Further, the permanent magnet or the balancing plate provides attraction in only one direction and thus provides a limited balancing effect.

### OBJECTS OF THE INVENTION

An object of the present invention is to provide a motor including a balancing magnet mounted to an upper end of an axle tube. The balancing magnet attracts a magnetically conductive means provided on a shaft base of a rotor, thereby maintaining rotational balance and starting balance of the rotor.

Another object of the present invention is to provide a motor including a balancing magnet mounted to an upper end of an axle tube. The balancing magnet attracts a shaft of a rotor, thereby maintaining rotational balance and starting balance of the rotor. A further object of the present invention is to provide a motor including a balancing magnet mounted to an upper end of an axle tube. A gap between the balancing magnet and a magnetically conductive means provided on a shaft base of a rotor is relatively small to prevent dust from entering the axial tube and a bearing mounted in the axial tube.

### SUMMARY OF THE INVENTION

In accordance with an aspect of the invention, a motor comprises an axial tube, a rotor, a balancing magnet, and a magnetically conductive means.

The axial tube receives a bearing and is mounted in a stator. The rotor includes an axial base formed on an inner face thereof and a shaft extending from the axial base, with the shaft extending through the bearing. The balancing magnet is mounted to the upper end of the axial tube and includes at least one face. The magnetically conductive means is provided on the shaft base of the rotor and includes at least one face. Said at least one face of the balancing magnet faces and attracts said at least one face of the magnetically conductive means to maintain rotational balance and starting balance of the rotor.

The balancing magnet includes an axial hole through which the shaft extends. An inner periphery delimiting the axial hole of the balancing magnet faces and attracts an outer periphery of the shaft.

In an embodiment of the invention, the magnetically conductive means is a magnetically conductive member mounted to a bottom end of the shaft base. The magnetically conductive member includes a bottom face facing and attracting the top face of the balancing magnet. The balancing magnet may be mounted in the upper end of the axial tube or bonded to a top face of the axial tube.

In another embodiment of the invention, the balancing magnet includes a first section fixed to a top face of the axial tube and a second section fixed to the inner periphery of the axial tube. An outer periphery of the magnetically conductive member faces the second section of the balancing magnet. An axial length of the magnetically conductive member is smaller than that of the second section of the balancing magnet.

In a further embodiment of the invention, the balancing magnet is mounted in the upper end of the axial tube and includes a conical recessed portion facing the magnetically conductive means. The magnetically conductive means is fixed to the bottom face of the shaft base and includes a conic section received in the conical recessed portion, with a gap being defined between the conic section of the magnetically conductive means and the conical recessed portion of the balancing magnet, with the conical recessed section of the balancing magnet facing the magnetically conductive means and the outer periphery of the rotor.

The shaft base may include a recessed portion to form a shoulder to which the magnetically conductive member is mounted.

In still another embodiment of the invention, the magnetically conductive means is integrally formed on the shaft at a portion adjacent to the shaft base.

Other objects, advantages and novel features of this invention will become more apparent from the following detailed description when taken in conjunction with the accompanying drawings.

### BRIEF DESCRIPTION OF THE DRAWINGS

FIG. 1 is a sectional view of a conventional heat dissipating fan with a rotational balancing structure;

FIG. 2 is an exploded perspective view of a first embodiment of a motor in accordance with the present invention;

FIG. 3 is a sectional view of the motor in FIG. 2;

FIG. 4 is an enlarged view of a circled portion in FIG. 3;

FIG. 5 is a sectional view illustrating a second embodiment of the motor in accordance with the present invention;

FIG. 6 is a sectional view illustrating a third embodiment of the motor in accordance with the present invention;

FIG. 7 is a sectional view illustrating a fourth embodiment of the motor in accordance with the present invention; and

FIG. 8 is a sectional view illustrating a fifth embodiment of the motor in accordance with the present invention.

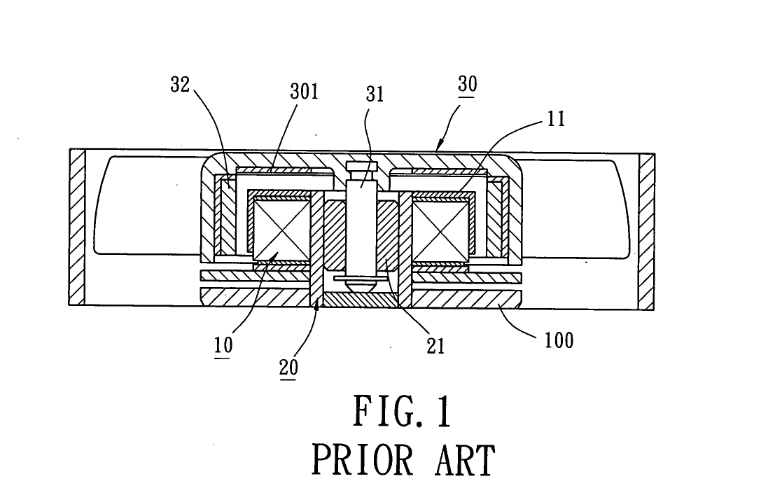

### DETAILED DESCRIPTION OF THE PREFERRED EMBODIMENTS

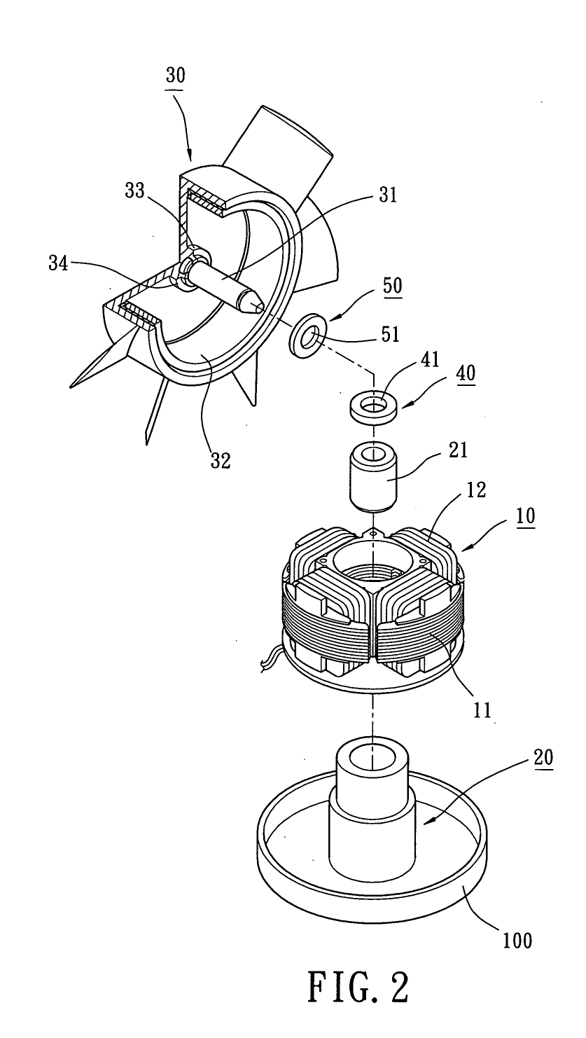

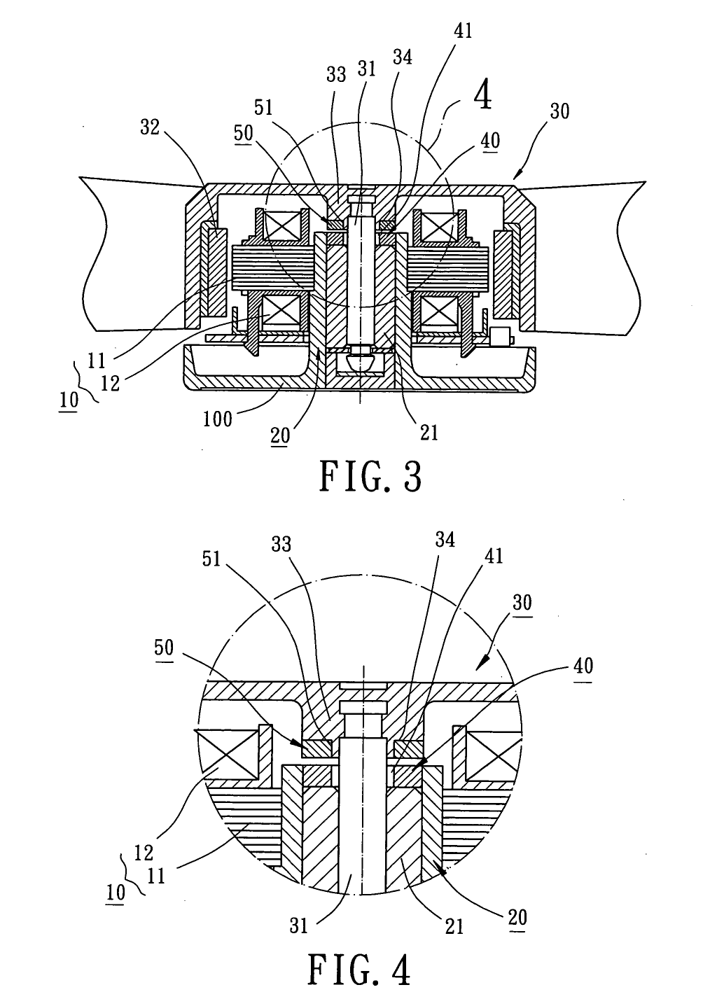

Referring to FIGS. 2 through 4, a first embodiment of a motor in accordance with the present invention comprises a stator 10, an axial tube 20, a rotor 30, a balancing magnet 40, and a magnetically conductive member 50. The stator 10 may be of a radial winding type or axial winding type. The stator 10 includes at least one pole plate 11 and at least one coil 12. When the coil 12 is supplied with alternating current, the pole plates 11 are inducted to cause alternating magnetization. The axial tube 20 can be a separate member or directly and integrally formed on a base 100. The axial tube 20 is extended through a central axial hole (not labeled) of the stator 10 and receives at least one bearing 21.

The rotor 30 includes a shaft base 33 formed on an inner face thereof, a shaft 31 extending from the shaft base 33, and an annular magnet 32. The shaft base 33 includes a reduced portion to form a shoulder 34. The shaft 31 is made of a magnetically conductive material and extends through the bearing 21. The annular magnet 32 surrounds the pole faces (not labeled) of the pole plates 11. The alternating magnetization of the pole plates 11 drives the rotor 30 to turn.

The magnetically conductive member 50 is made of a magnetically conductive material and includes a hole 51, with an inner periphery delimiting the hole 51 being fixed to the shoulder 34 of the shaft base 33 by force-fitting or glue. The balancing magnet 40 is made of a magnetically conductive material and mounted by force-fitting or glue into an upper end of the axial tube 20 that is adjacent to the magnetically conductive member 50. The balancing magnet 40 includes an axial hole 41 through which the shaft 31 extends, with a gap being defined between the shaft 31 and an inner periphery delimiting the axial hole 41, best shown in FIG. 4.

Still referring to FIG. 4, after assembly, the magnetically conductive member 50 is located on a bottom end of the shaft base 33 of the rotor 30, and the balancing magnet 40 is located in the upper end of the axial tube 20. Thus, no matter the motor is running, starting, or in a resting position, at least the balancing magnet 40 attracts the magnetically conductive member 50 from below to maintain rotational balance and rotational stability of the rotor 30. The magnetically conductive member 50 is relatively small and thus causes no burden to rotation of the rotor 30. Further, since the balancing magnet 40 is a permanent magnet, the balancing magnet 40 still attracts the magnetically conductive member 50 and the shaft 31 when the motor is in a resting position. This avoids temporary imbalance during starting of the rotor 30. Rotational balance and rotational stability of the rotor 30 are further improved.

Further, in addition to providing attraction to the magnetically conductive member 50 on the shaft base 33, the inner periphery delimiting the axial hole 41 of the balancing magnet 40 faces an outer periphery of the shaft 31. Namely, the balancing magnet 40 attracts the rotor 30 in two dimensions, which further improves rotational balance and rotational stability of the rotor 30. On the other hand, a distance between the magnetically conductive member 50 and the balancing magnet 40 can be adjusted to be smaller than a distance between an inner face of the rotor 30 and a top of the stator 10. Thus, the magnetically conductive member 50 and the balancing magnet 40 prevent dust from entering the axial tube 20 and the bearing 21, avoiding generation of oil stain in the bearing 21 and avoiding the bearing 21 from getting stuck.

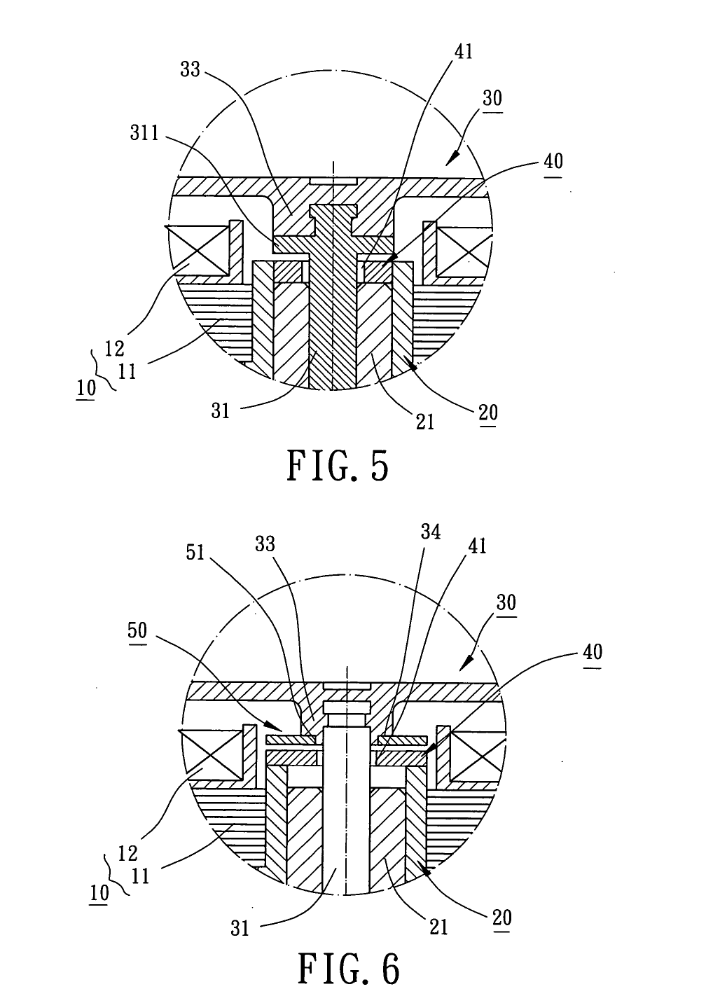

FIG. 5 illustrates a second embodiment of the invention, wherein the shoulder 34 in the first embodiment is omitted and the magnetically conductive member 50 is replaced with a magnetically conductive portion 311 integrally formed with the rotor 30. The magnetically conductive portion 311 is in contact with a bottom face of the shaft base 33. Thus, the top face of the balancing magnet 40 faces and attracts the bottom side of the magnetically conductive portion 311, and the inner periphery delimiting the axial hole 41 of the balancing magnet 40 faces and attracts the outer periphery of the shaft 31. The balancing magnet 40 attracts the rotor 40 in two dimensions, which further improves rotational balance and rotational stability of the rotor 30 during running and starting of the rotor 30. Entrance of dust into the axial tube 20 and the bearing 21 is avoided. Further, the number of elements of the motor is reduced to simplify the assembling procedure.

FIG. 6 illustrates a third embodiment of the invention, wherein the balancing magnet 40 is fixed (e.g., by bonding) to a top face of the axial tube 20. Further, the shaft base 33 of the rotor 30 can be of a smaller size, and the magnetically conductive member 50 has a diameter the same as that of the balancing magnet 40. Thus, the top face of the balancing magnet 40 faces and attracts the bottom side of the magnetically conductive member 50 with a larger area, and the inner periphery delimiting the axial hole 41 of the balancing magnet 40 faces and attracts the outer periphery of the shaft 31. The balancing magnet 40 attracts the rotor 40 in two dimensions, which further improves rotational balance and rotational stability of the rotor 30 during running and starting of the rotor 30. Entrance of dust into the axial tube 20 and the bearing 21 is avoided. Further, the number of elements of the motor is reduced to simplify the assembling procedure. Further, the magnetically conductive member 50 may be replaced with the magnetically conductive portion 311 of FIG. 5.

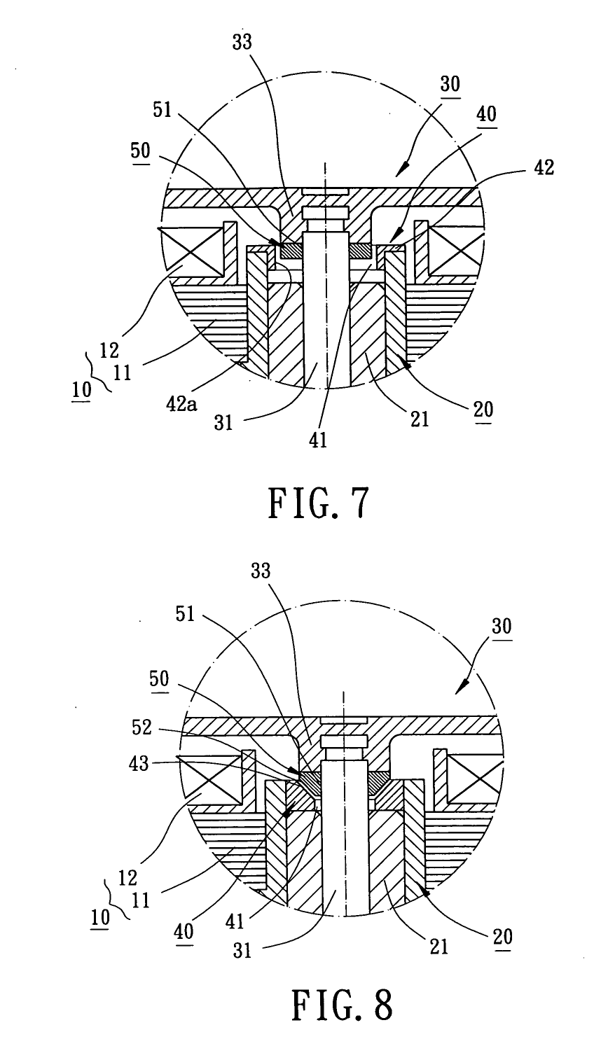

FIG. 7 illustrates a fourth embodiment of the invention, wherein the balancing magnet 40 is substantially L-shaped and includes a first section 42 fixed to a top face of the axial tube 10 and a second section 42a fixed to the inner periphery of the axial tube 20. The magnetically conductive member 50 is directly bonded to the bottom face of the shaft base 33 and mounted around the shaft 31, with an outer periphery of the magnetically conductive member 50 facing the second section 42a of the balancing magnet 40. An axial length of the magnetically conductive member 50 is smaller than that of the second section 42a of the balancing magnet 40. Thus, the second section 42a of the balancing magnet 40 faces the magnetically conductive member 50 and the outer periphery of the rotor 30, which further improves rotational balance and rotational stability of the rotor 30 during running and starting of the rotor 30. Entrance of dust into the axial tube 20 and the bearing 21 is avoided. Further, the number of elements of the motor is reduced to simplify the assembling procedure. Further, the magnetically conductive member 50 may be replaced with the magnetically conductive portion 311 of FIG. 5.

FIG. 8 illustrates a fifth embodiment of the invention, wherein the balancing magnet 40 is mounted in the upper end of the axial tube 20 and includes a conical recessed portion 43 facing the magnetically conductive member 50. The magnetically conductive member 50 is fixed to the bottom face of the shaft base 33 and includes a conic section 52 received in the conical recessed portion 43, with a gap being defined between the conic section 52 of the magnetically conductive member 50 and the conical recessed portion 43 of the balancing magnet 40. Thus, the conical recessed section 43 of the balancing magnet 40 faces the magnetically conductive member 50 and the outer periphery of the rotor 30, which further improves rotational balance and rotational stability of the rotor 30 during running and starting of the rotor 30. Entrance of dust into the axial tube 20 and the bearing 21 is avoided. Further, the number of elements of the motor is reduced to simplify the assembling procedure. Further, the magnetically conductive member 50 may be replaced with the magnetically conductive portion 311 of FIG. 5.

While the principles of this invention have been disclosed in connection with specific embodiments, it should be understood by those skilled in the art that these descriptions are not intended to limit the scope of the invention, and that any modification and variation without departing the spirit of the invention is intended to be covered by the scope of this invention defined only by the appended claims.

1. A motor comprising:
an axial tube having an upper end, the axial tube receiving a bearing and being adapted to be mounted in a stator;
a rotor including an axial base formed on an inner face thereof and a shaft extending from the axial base, the shaft extending through the bearing;
a balancing magnet mounted to the upper end of the axial tube and including at least one magnetic face; and
a magnetically conductive means provided on the shaft base of the rotor for attracting the balancing magnet, said magnetically conductive means including at least one magnetically-conductive face;
said at least one magnetic face of the balancing magnet facing and attracting said at least one magnetically-attractable face of the magnetically conductive means to maintain rotational balance and starting balance for the rotor.

2. The motor as claimed in claim 1, wherein the balancing magnet includes an axial hole through which the shaft extends.

3. The motor as claimed in claim 1, wherein the magnetically conductive means includes a hole through which the shaft extends.

4. The motor as claimed in claim 2, wherein the shaft is magnetically conductive and an inner periphery delimiting the axial hole of the balancing magnet faces and attracts an outer periphery of the shaft.

5. The motor as claimed in claim 1, wherein the balancing magnet includes a top face, the magnetically conductive mans is a magnetically conductive member mounted to a bottom end of the shaft base, the magnetically conductive member including a bottom face facing and attracting the top face of the balancing magnet.

6. The motor as claimed in claim 5, wherein the upper end of the axial tube that is adjacent to the shaft base of the rotor and the balancing magnetic is mounted in the upper end of the axial tube.

7. The motor as claimed in claim 5, wherein the balancing magnet is bonded to a top face of the axial tube.

8. The motor as claimed in claim 1, wherein the balancing magnet includes an inner periphery facing and attracting an outer periphery of the magnetically conductive means.

9. The motor as claimed in claim 8, wherein the upper end of the axial tube that is adjacent to the shaft base of the rotor and the balancing magnetic is mounted in the upper end of the axial tube.

10. The motor as claimed in claim 9, wherein the balancing magnet includes a first section fixed to a top face of the axial tube and a second section fixed to the inner periphery of the axial tube, with an outer periphery of the magnetically conductive means facing the second section for the balancing magnet, and with an axial length for the magnetically conductive member being smaller than that of the second section of the balancing magnet.

11. The motor as claimed in claim 2, wherein the balancing magnet is mounted in the upper end of the axial tube and includes a conical recessed portion facing the magnetically conductive means, the magnetically attractable, nonmagnetic member being fixed to the bottom face of the shaft base and including a conic section received in the conical recessed portion, with a gap being defined between the conic section of the magnetically conductive means and the conical recessed portion of the balancing magnet, with the conical recessed section of the balancing magnet facing the magnetically attractable, nonmagnetic member and the outer periphery of the rotor.

12. The motor as claimed in claim 5, wherein the shaft base includes a recessed portion to form a shoulder to which the magnetically attractable, nonmagnetic member is mounted.

13. The motor as claimed in claim 1, wherein the magnetically attractable, nonmagnetic member is integrally formed on the shaft at a portion adjacent to the shaft base.

14. The motor as claimed in claim 7, wherein the magnetically attractable, nonmagnetic member has a diameter the same as that of the balancing magnet.

15. The motor as claimed in claim 5, wherein the magnetically attractable, nonmagnetic member includes a hole through which the rotor extends.

16. The motor as claimed in claim 1, wherein the balancing magnet is bonded to a top face of the axial tube, and wherein the magnetically attractable, nonmagnetic member is integrally formed on the shaft at a portion adjacent to the shaft base.

17. The motor as claimed in claim 10, wherein the magnetically attractable, nonmagnetic member is integrally formed on the shaft at a portion adjacent to the shaft base.

18. The motor as claimed in claim 11, wherein the magnetically attractable, nonmagnetic member is integrally formed on the shaft at a portion adjacent to the shaft base.

19. The motor as claimed in claim 11, wherein the magnetically attractable, nonmagnetic member is mounted to a bottom end of the shaft base.

20. The motor as claimed in claim 19, wherein the magnetically attractable, nonmagnetic member includes a hole through which the rotor extends.
